(19) United States
(12) Patent Application Publication
(10) Pub. No.: US 2004/0168466 A1
(43) Pub. Date: Sep. 2, 2004

(54) Selection manifold for beverage dispenser

(76) Inventors: Jerry L. Landers, Memphis, IN (US); M. Scott Bennett, Louisville, KY (US); Hershel E. Fancher, New Albany, IN (US); Alan S. Lucas, Sellersburg, IN (US)

Correspondence Address: Jasper W. Dockrey, Brinks Hofer Gilson & Lione, P.O. BOX 10395, Chicago, IL, 60610, US

(21) Appl. No.: 10/790,957

(22) Filed: Mar. 1, 2004

Related U.S. Application Data
(62) Division of application No. 09/993,934, filed on Nov. 5, 2001, now Pat. No. 6,698,621.
Application No. 09/993,934 is a continuation-in-part of application No. 09/833,794, filed on Apr. 11, 2001, now abandoned.
(60) Provisional application No. 60/197,535, filed on Apr. 14, 2000.

(51) Int. Cl. B67D 5/56

(52) U.S. Cl. 62/390

(57) ABSTRACT

A selection manifold for use for use with a beverage dispenser apparatus for dispensing both carbonated and non-carbonated beverages and including a plurality of dispensing valves with a syrup and a water line feeding each dispensing valve further comprising a selection manifold connected between at least one of the water lines and sources of both carbonated and non-carbonated water, the manifold having a selecting mechanism allowing a user of the apparatus to easily switch between directing carbonated and non-carbonated water through the water line to the dispensing valve. In a preferred embodiment, the selection mechanism includes a portion that enables a viewer to easily determine whether carbonated or non-carbonated water is selected. In another preferred embodiment, the selection mechanism includes a lock to prevent inadvertent switching of the mechanism.

### REFERENCE TO EARLIER FILED APPLICATION

This application is a divisional application of U.S. Patent Ser. No. 09/993,934, filed Nov. 5, 2001, which is a CIP of U.S. patent application Ser. No. 09/833,794, filed Apr. 11, 2001, which claims the benefit of the filing date under 35 U.S.C. § 119(e) of provisional U.S. Patent Application Serial No. 60/197,535, filed Apr. 14, 2000, all of which are hereby incorporated by reference.

### BACKGROUND OF THE INVENTION

The present invention relates to a selection manifold for a beverage dispenser, such as a post-mix carbonated beverage dispensing system.

A post-mix carbonated beverage dispensing system makes its own carbonated water from a supply of municipal or well water, and then distributes the carbonated water to a plurality of post-mix valves. Each post-mix valve mixes carbonated water with syrup and effects dispensing of a complete beverage. These dispensers are typically found in fast food retailers, theaters, convention centers, sports facilities and the like, and are most often used to fill cups with beverage.

Most all of these plural flavor post-mix dispensers have some type of structure to distribute carbonated water from a single source which may be single or plural carbonator to a plurality of dispensing valves. There typically will be a minimum of four dispensing valves, and it is common to see up to twelve dispensing valves being supplied from a single carbonator.

Recently, consumers have desired the option of purchasing non-carbonated beverages at locations served by post-mix carbonated beverage systems. As a result, manufactures of such beverage dispensing systems have started to provide one or more valves that are connected to a source of chilled but non-carbonated water. These valves then mix a syrup with the non-carbonated water to provide a non-carbonated drink, such as lemonade.

While this additional consumer choice is good for the establishment selling the beverages, it causes problems for the equipment manufacturers and suppliers. Heretofore, the equipment has been built with a fixed number and position of valves that that are supplied with non-carbonated water. The problem is that consumer preferences change, or are unknown at the time equipment has to be purchased and installed. Thus, a beverage dispenser may be installed at a location with only one valve configured to dispense a non-carbonated beverage. However, in actual use, it may be determined that consumers would rather have other types of non-carbonated beverages than the type of carbonated beverage being dispensed. If a user wanted a different selection, so that more valves can dispense non-carbonated beverages, or wants to move the position of the dispenser valves from which non-carbonated beverages are dispensed, the beverage dispensing equipment would have to be modified. While this is difficult and expensive at best, it may be impossible in some systems because the systems are built so that the water (carbonated or non-carbonated) lines are insulated right up to the point where they attach onto the dispensing valves. Therefore, any change would require a complete tearing apart of the equipment.

To add flexibility to beverage dispensers, valve systems have been developed that allow a single dispensing valve to serve either carbonated or non-cabonated beverages. For example, post-mix valves are disclosed in U.S. Pat. No. 5,984,142 to Castaldi and U.S. Pat. No. 5,931,348 to Guadalupi. These systems are switchable, such that either carbonated or non-carbonated water will be delivered by a given dispensing valve. While these post-mix valves provide dispensing valves that can be adjusted at a customer site, neither system enables the valves to be secured in position so as to prevent unintentional switching from one type of water to the other. Further, neither system allows an inspector to easily determine whether a given valve is positioned to deliver carbonated or non-carbonated water.

Thus, there is a need for an improved beverage dispensing equipment that is more versatile, so that an equipment user can more easily change the configuration of the equipment so that different types of beverages can be dispensed as consumer preferences are learned or change.

### SUMMARY OF THE INVENTION

A selection manifold has been invented for use with a beverage dispenser that allows the user to easily change the dispenser's configuration. In the preferred embodiment, any dispensing valve on a dispenser can be converted from dispensing a carbonated beverage to a non-carbonated beverage. Additionally, the preferred selection manifold is preferably constructed to enable a selection mechanism to be locked into position to prevent inadvertent switching to a non-selected supply line. Also, the selection manifold is preferably configured to permit ready determination of the status of each selection mechanism in the manifold.

In one embodiment of the invention a selection manifold for use with a beverage dispenser includes a manifold block containing at least one cell, each cell having an outlet opening and at least first and second inlet openings. A selector mechanism is associated with each cell, and the selector mechanism is actionable between a first position in which fluid entering the cell from the first inlet opening may pass to the outlet opening and fluid from the second inlet is prevented from entering the cell, and a second position in which fluid entering the cell from the second inlet opening may pass to the outlet opening and fluid from the first inlet opening is prevented from entering the cell. A lock prevents unintentional change of the selector mechanism between the first and second positions.

In another embodiment of the invention, a selection manifold for use with a beverage dispenser includes a manifold block containing at least one cell, each cell having an outlet opening and at least first and second inlet openings. A selector mechanism is associated with each cell, where the selector mechanism includes a cap with a channel. The selector mechanism is actionable between a first position in which fluid entering the cell from the first inlet opening may pass to the outlet opening and fluid from the second inlet is prevented from entering the cell, and a second position in which fluid entering the cell from the second inlet opening may pass to the outlet opening and fluid from the first inlet opening is prevented from entering the cell.

In yet another embodiment of the invention, a selection manifold for use with a beverage dispenser includes a manifold block containing at least one cell, each cell having an outlet opening positioned intermediate to first and second inlet openings. A selector mechanism is associated with each cell and the selector mechanism includes a plunger valve having a seal. The seal of the selector mechanism is transversely actionable with respect to the outlet opening between a first position in which fluid entering the cell from the first inlet opening may pass to the outlet opening and fluid from the second inlet is prevented from entering the cell, and a second position in which fluid entering the cell from the second inlet opening may pass to the outlet opening and fluid from the first inlet opening is prevented from entering the cell.

In still another embodiment of the invention, a beverage selection manifold includes a manifold block containing one outlet opening and two or more inlet openings. A selector mechanism controls fluid communication between the outlet opening and any one of the inlet openings and includes a lock to prevent an unintentional change in selection state.

In a further embodiment of the invention, a selection manifold for use with a beverage dispenser includes a manifold block containing a chamber. The chamber has an outlet opening and a first inlet opening opposite a second inlet opening. A rod protrudes into the chamber through one of the first and second inlet openings. A fluid seal is mounted to an end of the rod, the fluid seal having a first side opposite a second side. The rod is actionable between a first position, in which the first side of the fluid seal isolates the first opening from the chamber and the second opening remains in communication with the chamber, and a second position, in which the second side of the fluid seal isolates the second opening from the chamber and the first opening remains in communication with the chamber.

In a still further embodiment of the invention, a beverage selection manifold includes a manifold block containing an outlet opening positioned intermediate to first and second opposed inlet openings. A fluid seal having a first seating surface opposite a second seating surface is moveable to a first position, in which the first seating surface seals the first inlet opening and the second inlet opening remains open, and to a second position, in which the second seating surface seals the second inlet opening and the first inlet opening remains open.

In another embodiment of the invention, a beverage selection manifold includes a cell within a manifold body, the cell including an outlet opening and first and second inlet openings. A removable cap includes a channel therein that is positionable adjacent to the cell in a first cap position and in a second cap position. The channel allows fluid communication between the outlet opening and the first inlet opening in the first position, and between the outlet opening and the second inlet opening in the second position.

In yet another embodiment of the invention, in a method of switching a supply line to a dispensing valve, a user selects the fluid supply to a beverage valve by activating a fluid seal between a first position, in which a first side of the fluid seal closes a first fluid supply line, while allowing fluid to flow through a second fluid supply line, and a second position in which a second side of the fluid seal closes the second fluid supply line, while allowing fluid to flow through the first fluid supply line.

In still another embodiment of the invention, in a method of switching a supply line to a dispensing valve, a user selects the fluid supply to a beverage valve by positioning a cap in a first position, in which a first side of the cap closes a first fluid supply line, while allowing fluid to flow through a second fluid supply line, and a second position, in which a second side of the cap closes a second fluid supply line, while allowing fluid to flow through the first fluid supply line.

In a further embodiment of the invention, a selection manifold for use with a beverage dispenser includes a valve body containing multiple cells, each cell having an outlet opening and first and second inlet openings. A rotatable shuttle valve is associated with each cell, the rotatable shuttle valve including first and second o-rings separated by a reduced diameter section. The shuttle valve is actionable between a first position, in which fluid entering the cell from the first inlet opening may pass to the outlet opening and fluid from the second inlet is prevented from entering the cell by the second o-rings, and a second position, in which fluid entering the cell from the second inlet opening may pass to the outlet opening and fluid from the first inlet opening is prevented from entering the cell by the fist o-rings. A retaining boss resides on the shuttle valve intermediate to first and second locking grooves and a locking plate is positioned on the valve body. The shuttle valve can be rotated, such that the retaining boss abuts the locking plate and the locking plate engages one of the first and second locking grooves to prevent unintentional change of the selector mechanism between the first and second positions.

In a still further embodiment of the invention, a selection manifold for use with a beverage dispenser includes a manifold block containing at least one cell, each cell having an outlet opening and at least first and second inlet openings. A selector mechanism is associated with each cell, the selector mechanism being actionable between a first position, in which fluid entering the cell from the first inlet opening may pass to the outlet opening and fluid from the second inlet is prevented from entering the cell, and a second position, in which fluid entering the cell from the second inlet opening may pass to the outlet opening and fluid from the first inlet opening is prevented from entering the cell. The selector mechanism includes a portion that extends past an outer edge of the manifold block enabling a viewer to determine the position of the selector mechanism associated with each cell.

In another embodiment of the invention, a beverage selection manifold includes a manifold body. A plurality of sections within the manifold body each include first and second outlet orifices and first and second inlet orifices. A plurality of removable caps that each include a channel therein. The caps are positionable adjacent to one of the sections in a first cap position and a second cap position. The channel provides a fluid outlet for the first outlet orifice in the first position and a fluid outlet for the second outlet orifice in the second position.

In yet another embodiment of the invention, in a beverage selection manifold for controlling fluid flow therein of carbonated and non-carbonated water for mixing with a syrup to form a beverage, the manifold includes a rectangular manifold body including multiple cells. Each cell has first and second inlet orifices and first and second outlet orifices. The first and second inlet orifices are connected to respective first and second elongated channels positioned in the rectangular manifold body. At least one detachable body is configured to stop fluid flow from a first outlet orifice in a first position and from a second outlet orifice in a second position.

In still another embodiment of the invention, a beverage selection manifold includes a section within a manifold body. The section includes first and second outlet openings and first and second inlet openings. A positionable body including a fluid path therein is positionable adjacent to the section in a first body position and a second body position. The fluid path provides a fluid outlet for the first outlet opening in the first position and a fluid outlet for the second outlet opening in the second position.

In a further embodiment of the invention, a method of switching a supply line to a mixing and dispensing valve includes providing a plurality of mixing and dispensing valves in fluid communication with a manifold block, the manifold block having a carbonated water channel and a noncarbonated water channel therethrough and a plurality of paired first and second outlet openings, each pair associated with one of the mixing and dispensing valves. A removable selector is provided for each of the plurality of mixing and dispensing valves. One of the removable selectors is connected to one of a carbonated water supply or a non-carbonated water supply to a selected one of the plurality of mixing and dispensing valves by positioning a first removable selector in a first position in which the removable selector closes the first paired outlet opening, while allowing carbonated water or non-carbonated water to flow through the second paired outlet opening. Thereafter switching the first removable selector body to select the other of a carbonated water supply or a non-carbonated water supply to the selected one of the plurality of mixing and dispensing valves by positioning the first removable selector body in a second position in which the first removable selector body closes the second paired outlet opening, while allowing carbonated water or noncarbonated water to flow through the first paired outlet opening.

In a still further embodiment of the invention a method of setting up a beverage dispenser includes providing the beverage dispenser with a beverage selection manifold including a manifold block having first and second inlet channels therethrough and at least five paired first and second outlet openings therein. A removable selector body is associated with each paired first and second outlet opening. One of the removable selector bodies is positioned in a first position in which carbonated water entering the manifold block through the first inlet channel passes through the first paired outlet opening and noncarbonated water from the second inlet channel is prevented from passing through the second outlet opening. Another of the removable selector bodies is positioned in a second position in which noncarbonated water entering the manifold block through the second inlet channel passes through the second paired outlet opening and carbonated water from the first inlet channel is prevented from passing through the first paired outlet opening.

In another embodiment of the invention, in a beverage selection manifold for controlling fluid flow therein of carbonated and non-carbonated water for mixing with a syrup to form a beverage, the manifold includes a manifold body including multiple cells, each cell having first and second inlet orifices and first and second outlet orifices. The first and second inlet orifices are connected to respective first and second elongated channels positioned in the manifold body. At least one detachable body is configured to stop fluid flow from a first outlet orifice in a first position and from a second outlet orifice in a second position. A retaining device prevents unintentional change of the at least one detachable body between the first and second position.

In yet another embodiment of the invention, in a beverage selection manifold for controlling fluid flow therein of carbonated and non-carbonated water for mixing with a syrup to form a beverage, the manifold includes a rectangular manifold body including multiple cells, each cell having first and second inlet orifices and first and second outlet orifices. The first and second inlet orifices are connected to respective first and second elongated channels positioned in the rectangular manifold body. At least one detachable body is configured to stop fluid flow from a first outlet orifice in a first position and from a second outlet orifice in a second position. The at least one detachable body further includes a portion that extends past an outer edge of the rectangular manifold body, such that the portion can be grasped by a user for positioning the at least one detachable body in the first position or the second position.

The invention and its advantages will best be understood in view of the attached drawings.

### BRIEF DESCRIPTION OF THE DRAWINGS

FIG. 1 is a perspective view of a combined ice and beverage dispenser, utilizing the preferred embodiment of the present invention.

FIG. 2 is a schematic representation of the water system used in the beverage dispenser of FIG. 1, showing the preferred selection manifold.

FIG. 3 is a front elevational view of the selection manifold of FIG. 2.

FIG. 4 is a top plan view of the selection manifold of FIG. 2.

FIG. 5 is a right side elevational view of the selection manifold of FIG. 2.

FIG. 6 is a left side elevational view of the selection manifold of FIG. 2.

FIG. 7 is a bottom plan view of the selection manifold of FIG. 2.

FIG. 8 is a back elevational view of the selection manifold of FIG. 2.

FIG. 9 is a cross-sectional view taken along line 9-9 of FIG. 7.

FIG. 10 is an elevational view of a shuttle valve member used in the selection manifold of FIG. 2.

FIG. 11 is a perspective view of the shuttle valve member of FIG. 10.

FIG. 12 illustrates the shuttle valve member of FIG. 10 in a position that allows fluid communication between the top flow channel (non-carbonated water) and the outlet orifice (dispensing valve).

FIG. 13. illustrates the shuttle valve member of FIG. 10 in a position which allows fluid communication between the bottom flow channel (carbonated water) and the outlet orifice (dispensing valve).

FIGS. 14A and 14B illustrate two adjacent shuttle valves members of FIG. 10 in a locked state.

FIGS. 15A and 15B illustrate two adjacent shuttle valves member of FIG. 10 in an unlocked state.

FIG. 16 is a schematic view of a second embodiment of a selection manifold of the present invention in the non-carbonated water position.

FIG. 17 is a schematic view of the selection manifold of FIG. 16 in the carbonated water position.

FIG. 18 is a perspective view of a third embodiment of a selection manifold of the present invention which utilizes a selector cap to control the desired fluid connection path.

FIG. 19 is a perspective view of selector cap used in the selection manifold of FIG. 18.

FIG. 20 is a perspective view of the selection block used in the selection manifold of FIG. 18.

FIG. 21 is a cross-sectional view of the selection manifold of FIG. 18 which illustrates the selector cap positioned to supply non-carbonated water to the dispensing valve.

FIG. 22 is a cross-sectional view of the selection manifold of FIG. 18, which illustrates the selector cap positioned to supply carbonated water to the dispensing valve.

FIG. 23 is a schematic view of a fourth embodiment of a selection manifold of the present invention positioned to supply carbonated water to the dispensing valve.

FIG. 24 is a schematic view of the selection manifold of FIG. 23 positioned to supply non-carbonated water to the dispensing valve.

FIG. 25 is an exploded view of a fifth embodiment of a selection manifold for use on a single post-mix beverage dispensing valve.

FIG. 26 is a perspective, exploded view of the selection manifold of FIG. 25.

FIG. 27 is a perspective view of a sixth embodiment of a selection manifold and mounting blocks for use with multiple post-mix beverage dispensing valves.

FIG. 28 is an exploded view of the selection manifold of FIG. 27 showing only one mounting block and post-mix beverage dispensing valve.

FIG. 29 is a schematic view of a seventh embodiment of a selection manifold in a beverage dispensing system.

FIG. 30 is an exploded, partial cross-sectional view of the selection manifold of FIG. 29.

### DETAILED DESCRIPTION OF THE DRAWINGS AND PREFERRED EMBODIMENTS OF THE INVENTION

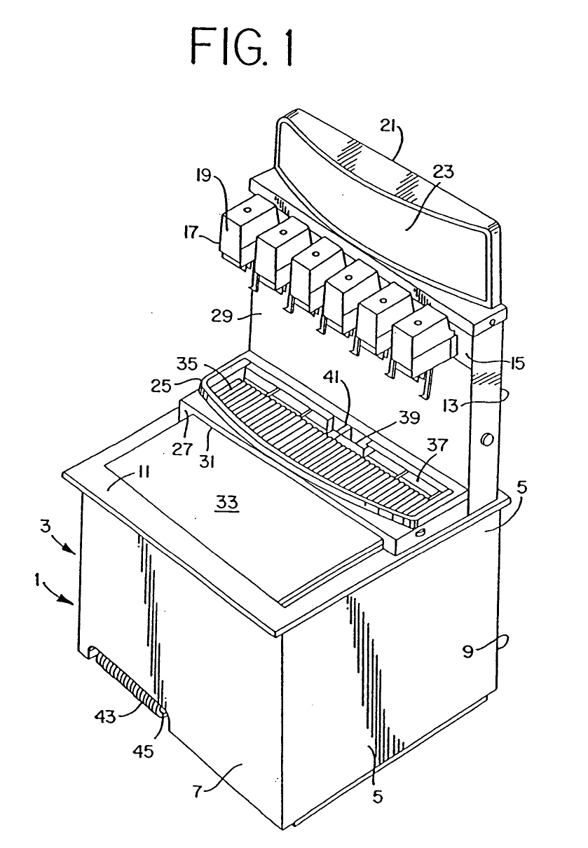

Referring now to FIG. 1, a beverage and ice dispenser utilizing the present invention is generally indicated by the numeral 1. The dispenser has a cabinet or box 3 which has side walls 5, a front wall 7 and a rear wall 9. A trim ring 11 covers the top of the cabinet and covers an opening in a counter in which the dispenser is installed. A tower 13 extends upward from the top of the cabinet. The tower has plural dispenser valves 15 arranged in a line along the front. The valves have levers 17 which may be moved to open the valves for mixing carbonated or non-carbonated water with flavored syrups to produce the desired soft drinks. Alternatively, the valves may be operated by pushing the front faces 19 of the valves.

A large curved merchandiser advertisement 21 appears at the top of the tower. The merchandiser is backlit and has a translucent front panel 23 on which a message appears.

A drain pan 25 below the valves catches overflows from the cups under the valves and ice which is spilled from overfilled cups. The drain pan 25 is mounted on top of the trim ring 11. Lifting up on the front 27 of the drain pan and pulling upward on the drain pan removes the drain pan from the top of the cabinet 3. Lifting or sliding the splash panel 29 upward allows the splash panel to be rocked away from the tower for cleaning. The drain pan 25 has a rectangular opening 31 in its front 27, through which the ice bin door 33 slides or rotates. After the drain pan has been removed, lifting the front edge of the sliding door upward 33 and tiling the door rearward enables the door to be removed from holders at the sides. In that manner, full access is supplied to the ice storage bin for cleaning the bin and the top of the cold plate, which is integral with the bin. The dispenser may be removed from the counter top by lifting upward on the supporting flanges, which are covered by the trim ring 11.

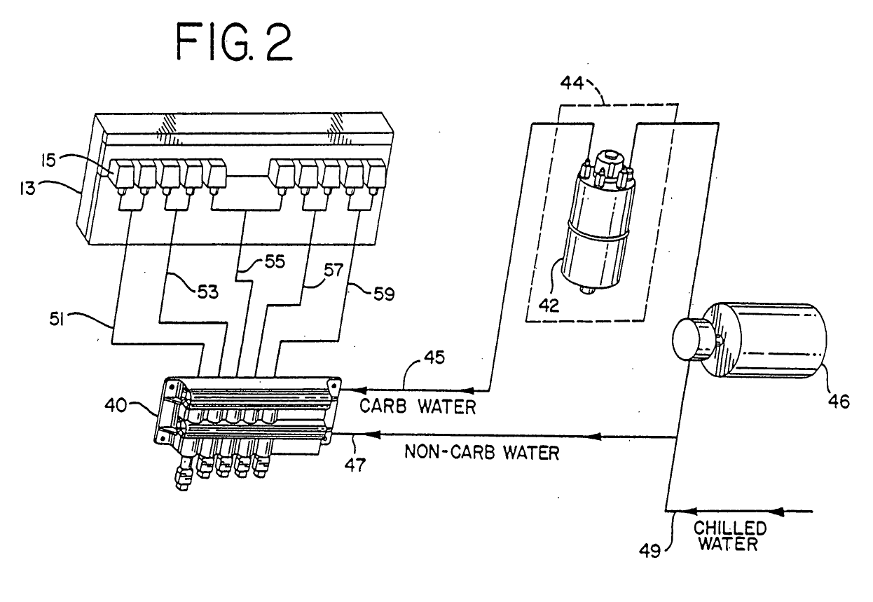

In the above mentioned respects, the beverage and ice dispenser of the present invention is like prior art beverage and ice dispensers, such as those disclosed in U.S. Pat. Nos. 5,397,032 and 4,641,763, which are hereby incorporated by reference. The beverage and ice dispenser 1 however includes a unique selection manifold 40 as shown in FIG. 2. FIG. 2 also shows a carbonator 42 which is disposed in a chilled zone 44 and a carbonator pump 46. In the embodiment depicted, a carbonated water line 45 and a non-carbonated water line 47 both feed the selection manifold 40, chilled water being supplied to system by line 49. Five water lines 51, 53, 55, 57 and 59 extend between the selection manifold 40 and the dispensing valves 15 on the tower 13. In the embodiment depicted in FIG. 2, there are ten dispensing valves 15, and thus each of water lines 51, 53, 55, 57 and 59 branches to feed two dispensing valves. It would of course be possible to increase the size of the selecting manifold 40 and the number of water lines so that each dispensing valve 15 was supplied by its own water line coming from the selection manifold 40, or fewer lines could be used so that more valves could be paired together.

The carbonator 42, carbonator pump 46 and dispensing valves 15 can be of any of several known configurations, and are therefore not described in any further detail.

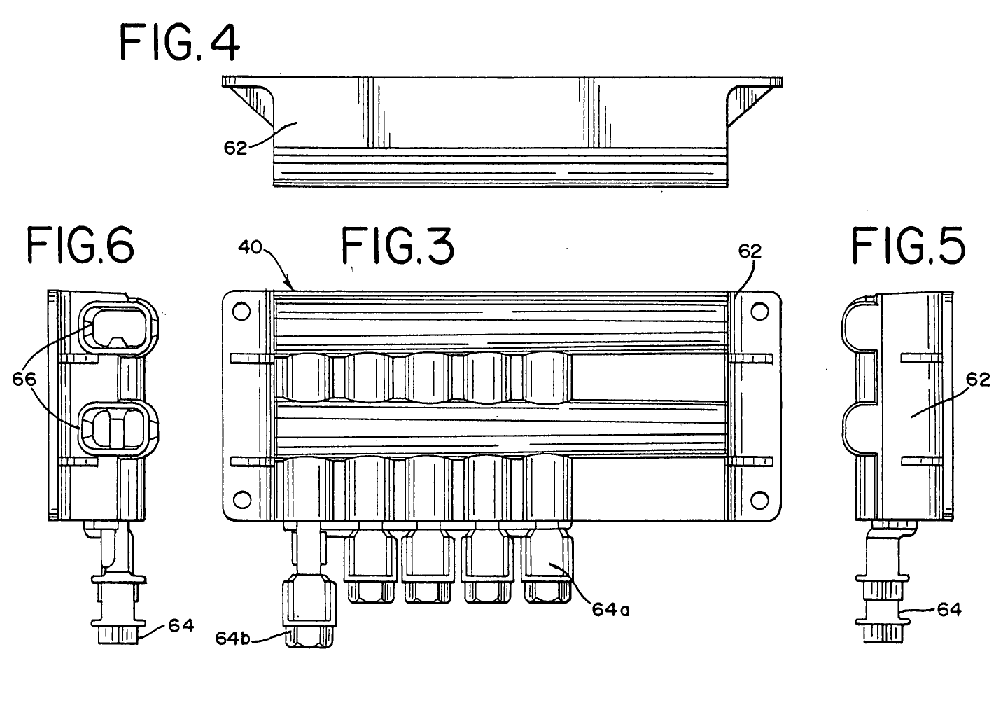

The preferred selection manifold 40 is shown in detail in FIGS. 3-15. It is made with a manifold block, which in this embodiment is a valve body 62. The valve body may be injection molded from a thermoplastic material. The depicted valve body 62 has five cells, each containing a selection mechanism, which in this case is a shuttle valve member 64. Two specific shuttle valve members 64a and 64b will be discussed to explain the operation of the selection manifold 40. In one end (FIG. 6) the valve body includes channel plugs 66. Channels 60 and 66 in the valve body are made by core pins during the injection molding process. The holes through which those core pins are withdrawn must be plugged in some fashion. Besides the plugs 66, a cap could be secured to cover the end of the valve body.

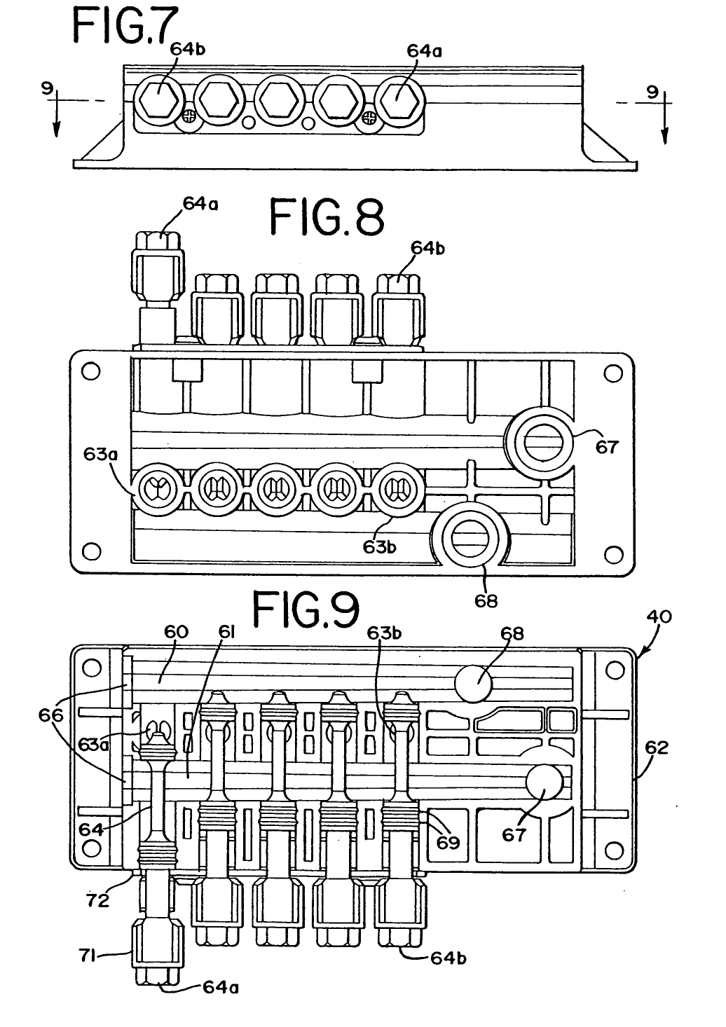

In the back (FIG. 8) the valve body contains two inlets, 67 and 68, as well as an outlet 63 for each of the five cells within the body. The outlets are connected to water lines 51, 53, 55, 57 and 59. Inlet 67 is connected to non-carbonated water line 47 and inlet 68 is connected to carbonated water line 45 coming from carbonator 42 (FIG. 2).

As shown in FIG. 9, the shuttle valve members 64 are each fitted with three O-rings 69. These O-rings allow the shuttle valve member 64 to seal off any flow from the cell in which they are housed out the bottom of the valve body. Also, depending on their position, the O-rings seal between the internal flow channels (60 and 61) and the outlets 63.

For example, when shuttle valve member 64a is in the position shown in FIG. 9, carbonated water entering the valve body 62 through inlet 68 is allowed to travel through channel 60 and exit through outlet 63a. On the other hand, shuttle valve member 64b allows non-carbonated water entering the valve body 62 through inlet 67 to travel through channel 61 and exit through outlet 63b. Of course, carbonated water in channel 60 cannot exit through any of the outlets 63 except 63a. Also, non-carbonated water in channel 61 is prevented from exiting outlet 63a by shuttle valve member 64a, with the O-rings sealing inside the valve body 62.

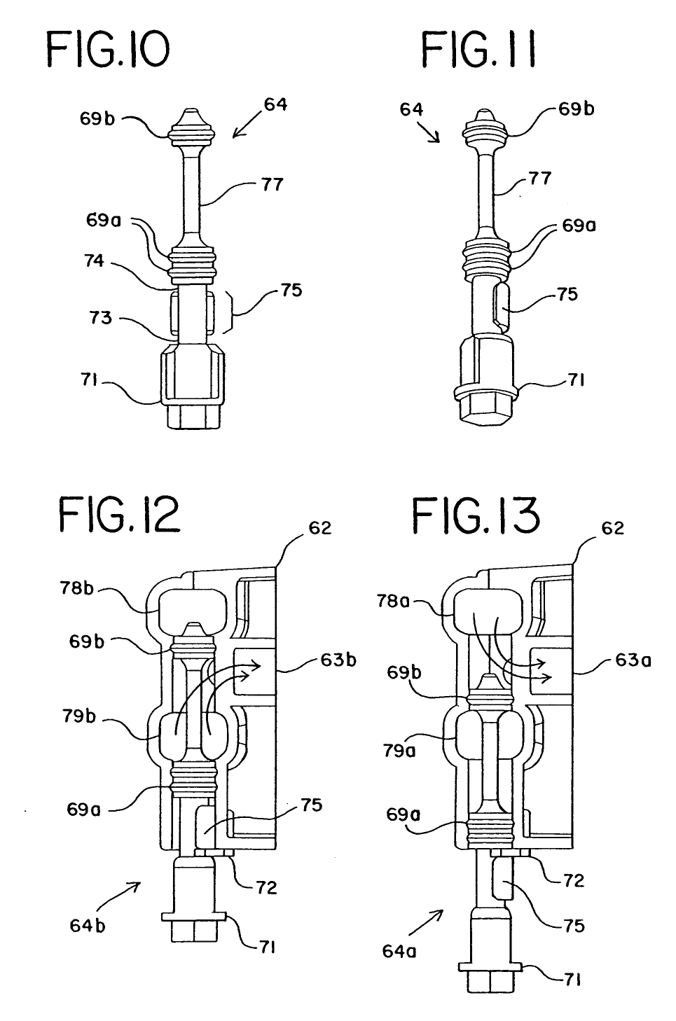

To prevent the shuttle valve member 64 from being accidentally moved out of its desired position, either by an inadvertent force on the handle 71 of the shuttle valve member extending out of the valve body, or by differences in pressure between the two channels 60 and 61, a locking plate 72 (FIG. 9) is preferably provided. The locking plate 72 cooperates with locking grooves 73 and 74 and a retaining boss 75 formed on the shuttle valve member 64 and best seen in FIGS. 10 and 11. Locking groove 73 is used to lock the shuttle valve member in an “in” position, and locking groove 74 is used to lock the shuttle valve member 64 in an “out” position. The reduced diameter section 77 of the shuttle valve member allows for fluid to flow within the cell in which shuttle valve member 64 is placed, as shown in FIGS. 12 and 13. O-rings 69a provide a lower sliding seal and O-ring 69b provides an upper sliding seal. FIG. 12 shows the shuttle valve member set for non-carbonated water. The carbonated water inlet 78a into the cell is blocked by the upper sliding seal and O-rings 69b. However, non-carbonated water can enter through inlet 79b and flow out the outlet 63b. FIG. 13 shows the valve set for carbonated water, which enters through inlet 78a and exits through outlet 63a. However, inlet 79a is blocked by O-rings 69b. In both cases O-rings 69a prevent water from leaking out the bottom of the valve body 62.

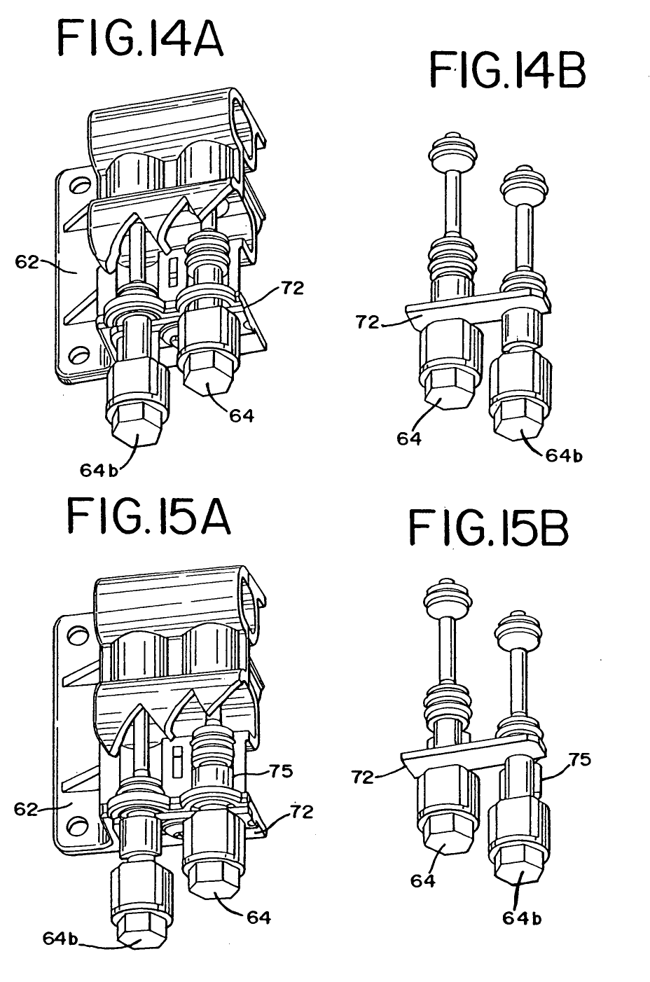

FIGS. 14A and 15A show the internal aspects of the valve body 62 and how the shuttle valve locking plate 72 is used. FIGS. 14B and 15B show just the locking plate 72 and the shuttle valve member 64. The locking plate 72 includes a boss or opening that allows the shuttle valve member to be retracted or extended when the valve is in one position, (FIGS. 15A and B) but when the shuttle valve member is rotated about its axis, such as by 180°, the retention boss 75 interferes with the locking plate, preventing the shuttle valve member from sliding in or out (FIGS. 14A and B).

As shown in FIGS. 3, and 8-9, each handle 71 extends past the outer edge of selection manifold 40. By providing a section of each shuttle valve 64 that is visible after the selection manifold is mounted to a dispenser, an inspector can easily determine the position of each valve. This feature of the invention is a distinct advantage over prior art systems that require detailed inspection or sampling to determine whether carbonated or non-carbonated water is selected.

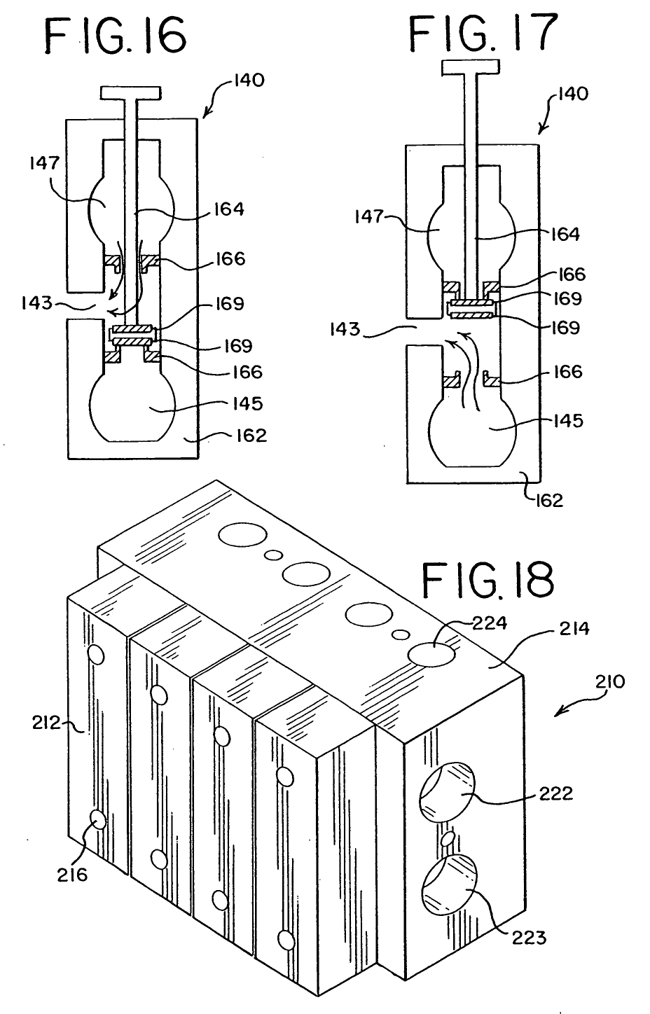

A second embodiment of a selection manifold 140 is shown in FIGS. 16 and 17. This embodiment uses a direct acting plunger inside the cell within the manifold body 162. Sealing washers 169 are used to seal against valve seats 166. In the position shown in FIG. 16, non-carbonated water 147 can flow out of outlet 143. In the position shown in FIG. 17, carbonated water 145 can flow out of outlet 143. In similarity to the foregoing embodiment, the position of stem 164, and hence, the position of the valve, can be easily determined by simply viewing selection manifold 140.

Those skilled in the art will appreciate that the selector mechanisms described above utilize a sealed valve system. Accordingly, when switching from one supply line to another, there is no need to relieve the pressure in the supply lines prior to changing the valve position. By eliminating the need to depressurize supply lines, numerous time-consuming procedures, such as turning power supplies off and on and bleeding supply lines can be avoided. Further, spillage of water, which can damage counter tops and cabinets is also avoided.

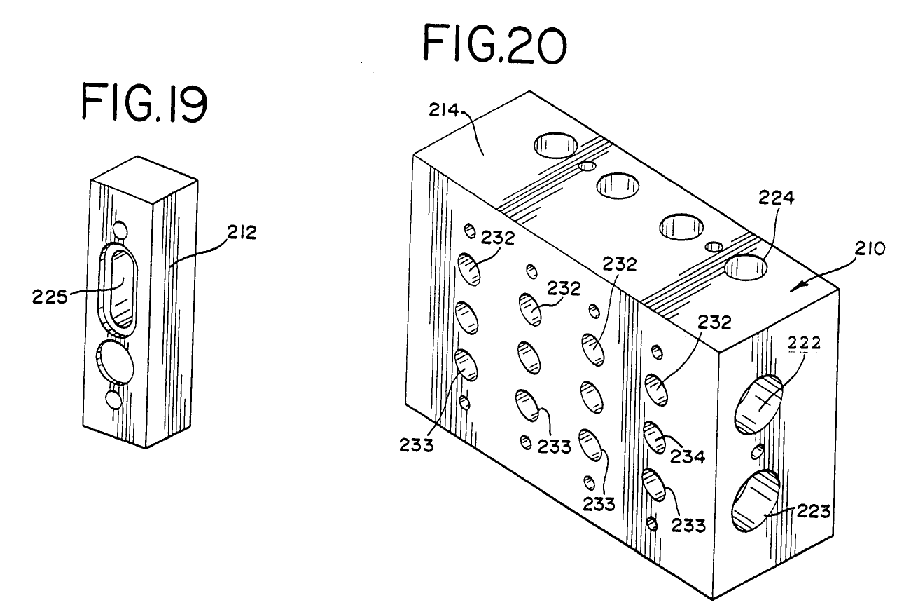

A third embodiment of a selection manifold 210 is shown if FIGS. 18-22. In this embodiment the selection mechanism is a selector cap 212 that is held onto the manifold body 214 by retention screws 216. The body 214 has two inlets 222 and 223 and an outlet 224 for each cell in the body. Holes 232 in the face of the body connect with a flow channel extending inwardly from inlet 222. Holes 233 also in the face of the body connect with a flow channel extending inwardly from inlet 223. Each cell also has another hole 234 in the face of the body, connecting with the outlet 224 for the cell.

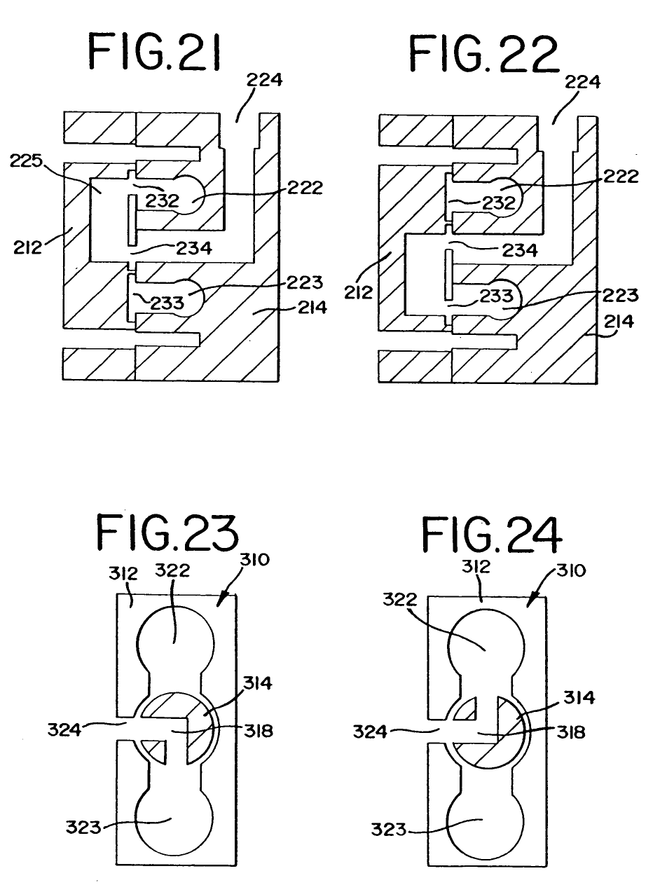

The selector cap 212 has an elongated channel 225 in one face. This channel does not open to any other face of the cap. The channel 225 extends from the center of the face off to one side by a distance equal to the distance between holes 232 and 234 (or holes 233 and 234) in the face of the manifold body 214. FIGS. 21 and 22 show the cap 212 attached to the face of the body 214. In one position, FIG. 21, non-carbonated water from inlet 222 is able to pass through the cell to the outlet 224, while carbonated water from inlet 223 is blocked. In the position shown in FIG. 22, carbonated water is allowed to pass through the cell in the selection manifold. As readily seen in FIGS. 18-22, cap 212 is repositioned on manifold body 214 by flipping the cap over and reattaching retention screws 216.

A fourth embodiment of the selection manifold 310 of the present invention is shown in FIGS. 23 and 24. The manifold has a body 312 and a selector mechanism which comprises a rotating stop cock or ball valve 314. Depending on the position of the ball valve 314, carbonated water from inlet 323 (FIG. 23) on non-carbonated water from inlet 322 (FIG. 24) is permitted to flow through internal channel 318 to outlet 324.

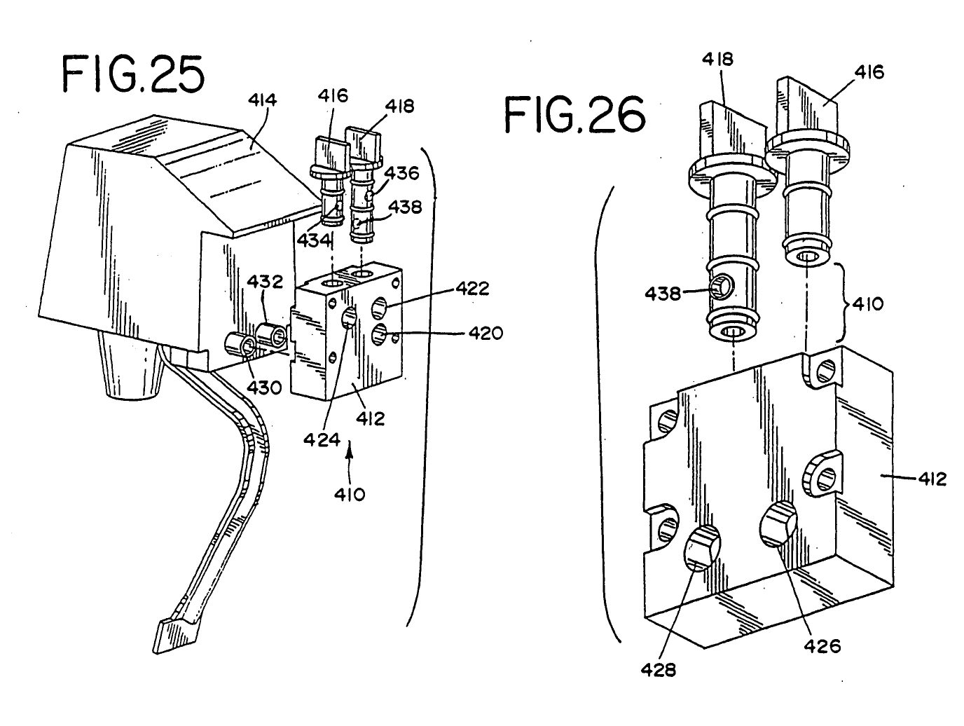

A fifth embodiment of a selection manifold 410 is shown in FIGS. 25-26. In this embodiment the selection manifold is built into a mounting block 412 used to mount a post-mix beverage dispensing valve 414 onto a beverage dispenser. A two-way syrup valve 416 and a three-way water valve 418 fit in the mounting block 412. Carbonated water enters the block 412 through port 420. Non-carbonated water enters the block through port 422. Syrup enters the block through port 424. The stem of each of valves 416 and 418 have a channel through their center, open at the bottom, that communicates respectively with syrup outlet port 426 and water outlet port 428 on block 412, which connect onto fittings 430 and 432 on the back of mixing valve 414. The syrup valve 416 has only one inlet 434, scaled with an O-ring (not shown). The water valve 418 has two inlets 436 and 438 when the valve 418 is inserted into mounting block 412 in the position shown in FIGS. 25 and 26, inlet 436 mates with port 422 so that non-carbonated water flows through the selection manifold 410. If the valve 418 is rotated 180°, inlet 438 mates with port 420, and carbonated water flows through selection manifold 410.

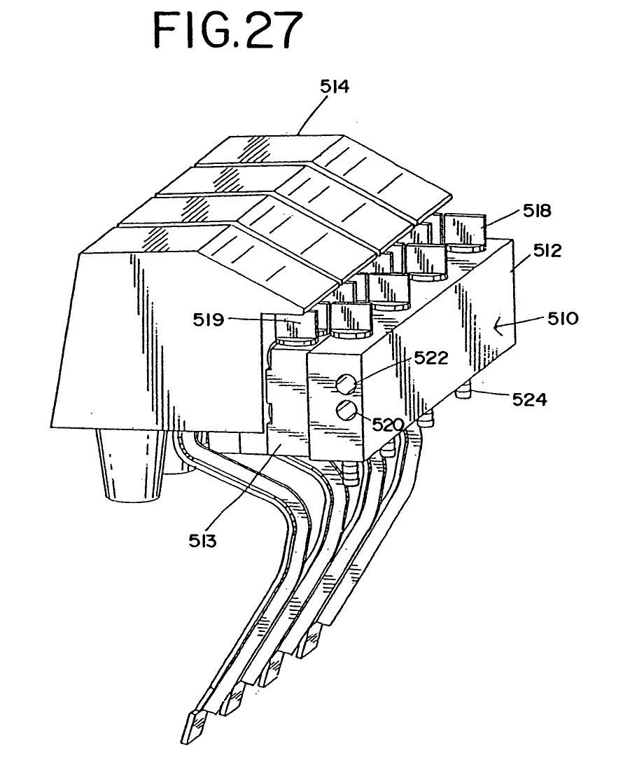

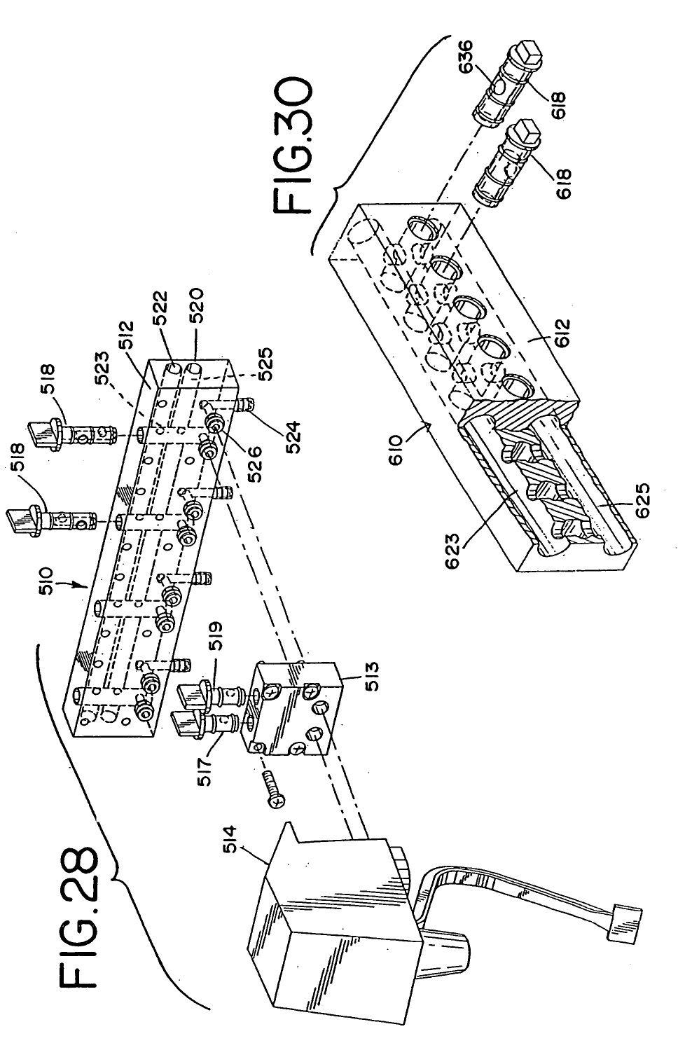

A sixth embodiment of a selection manifold 510 is shown in FIGS. 27-28. This selection manifold consists of four sets of water and syrup valves in one block 512. Each set is configured like the valves 416 and of FIG. 25. The entire manifold 510 also acts as a mounting block to mount multiple post-mix beverage dispensing valves 514 to a beverage dispensing machine. Individual valve blocks 513, with simple two-way valves 517 and 519, are mounted on the back of each post-mix dispensing valve 514. These valve blocks 513 allow water and syrup flow to be shut off to the valves 514. The selection manifold has one inlet port 520 for carbonated water and one inlet port 522 for non-carbonated water. Channels 523 and 525 extend from these inlet ports through the length of the block 512, supplying carbonated water and non-carbonated water to the individual water valves 518. Syrup inlets 524 allow syrup to flow into channels in the block 512 and out through syrup outlets 526. There is one set of syrup inlets and outlets for each block 513 and valve 514.

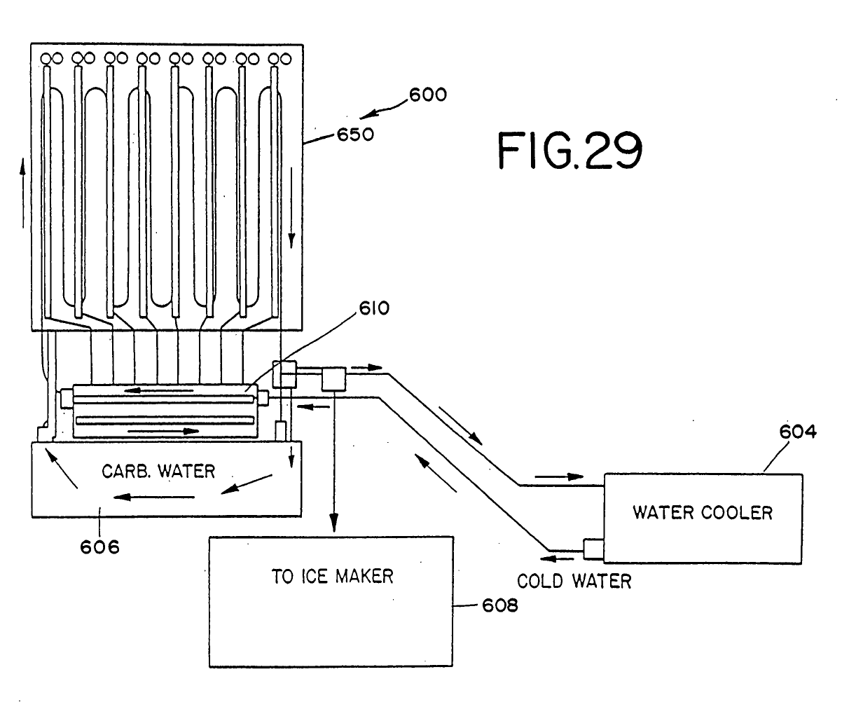

A seventh embodiment of a selection manifold 610 is shown in FIG. 30, and used in the beverage dispensing system shown in FIG. 29. Carbonated water flows through channels 625 in block 612, while non-carbonated water flows through channels 623. Selector valves 618 can be rotated 180° so that water from one of the channels 623 and 625 flows through the inlet 636 in the selector valve and out the back of block 612, where it connects to lines going through cold plate 650 in the beverage dispensing system 600. Cold water from water cooler 604 supplies a water to a carbonator 606, and optionally an ice makes 608.

The present invention can be used with other types of beverage dispensing systems than the beverage and ice dispenser 1. Counter-electric and remote carbonation systems can also use the selection manifold of the present invention. In addition to switching between carbonated and non-carbonated water, the system could be designed to switch between two or more beverages such as sodas, beers and wines.

1. A selection manifold for use with a beverage dispenser comprising:
a) a manifold block containing at least one cell, each cell having an outlet opening and at least first and second inlet openings;
b) a selector mechanism associated with each cell, the selector mechanism being actionable between
i) a first position in which fluid entering the cell from the first inlet opening may pass to the outlet opening and fluid from the second inlet is prevented from entering the cell, and
ii) a second position in which fluid entering the cell from the second inlet opening may pass to the outlet opening and fluid from the first inlet opening is prevented from entering the cell; and
c) a lock to prevent unintentional change of the selector mechanism between the first and second positions.

2. The selection manifold of claim 1 wherein the manifold block comprises at least two cells.

3. The selection manifold of claim 2 wherein the first inlet opening for each cell is supplied by a first manifold block inlet and the second inlet opening for each cell is supplied by a second manifold block inlet opening.

4. A selection manifold for use with a beverage dispenser comprising:
a) a manifold block containing at least one cell, each cell having an outlet opening and at least first and second inlet openings; and
b) a selector mechanism associated with each cell, wherein the selector mechanism comprises a cap with a channel, the selector mechanism being actionable between
i) a first position in which fluid entering the cell from the first inlet opening may pass to the outlet opening and fluid from the second inlet is prevented from entering the cell, and
ii) a second position in which fluid entering the cell from the second inlet opening may pass to the outlet opening and fluid from the first inlet opening is prevented from entering the cell.

5. The selection manifold of claim 4 wherein the first and second inlet openings reside on either side of the outlet opening.

6. The selection manifold of claim 5 wherein the channel provides a fluid conduit through which fluid enters the block though an inlet opening adjacent to the outlet opening.

7. (Original) A selection manifold for use with a beverage dispenser comprising:
a) a manifold block containing at least one cell, each cell having an outlet opening positioned intermediate to first and second inlet openings; and
b) a selector mechanism associated with each cell, wherein the selector mechanism comprises a plunger valve having a seal, the seal of the selector mechanism being transversely actionable with respect to the outlet opening between
i) a first position in which fluid entering the cell from the first inlet opening may pass to the outlet opening and fluid from the second inlet is prevented from entering the cell, and
ii) a second position in which fluid entering the cell from the second inlet opening may pass to the outlet opening and fluid from the first inlet opening is prevented from entering the cell.

8. A beverage selection manifold comprising a manifold block containing one outlet opening and two or more inlet openings and a selector mechanism that controls fluid communication between the outlet opening and any one of the inlet openings, wherein the selector mechanism includes a lock to prevent an unintentional change in selection state.

9. The beverage selection manifold of claim 8 further comprising a multiple cells, each having an outlet opening and a selector mechanism.

10. The beverage selection manifold of claim 8 wherein the selector mechanism allows selection between carbonated water and non-carbonated water.

11. The beverage selection manifold of claim 8 wherein the selector mechanism allows selection, between two or more beverages, including soda, beer and wine.

12. The beverage selection manifold of claim 8 wherein the selector mechanism includes a portion that extends past an outer edge of the manifold block enabling a viewer to determine the position of the selector mechanism associated with each cell.

13. The beverage selection manifold of claim 1 wherein the selector mechanism includes a portion that extends past an outer edge of the manifold block enabling a viewer to determine the position of the selector mechanism associated with each cell.

14. The beverage selection manifold of claim 8 wherein the selector mechanism comprises a shuttle valve, and wherein the lock comprises a movable retaining boss mounted to a section of the shuttle valve and a locking plate that abuts against the retaining boss when the retaining boss is moved into an aligned position with the locking plate.

15. The beverage selection manifold of claim 8 wherein the selector mechanism comprises a cap with a fluid channel therein, and wherein the lock comprises a retaining device to hold the cap against the manifold block.

16. A selection manifold for use with a beverage dispenser comprising:
a) a manifold block containing a chamber, the chamber having an outlet opening and a first inlet opening opposite a second inlet opening;
b) a rod protruding into the chamber through one of the first and second inlet openings; and
c) a fluid seal mounted to an end of the rod, the fluid seal having a first side opposite a second side,
wherein the rod is actionable between a first position in which the first side of the fluid seal isolates the first opening from the chamber and the second opening remains in communication with the chamber, and a second position in which the second side of the fluid seal isolates the second opening from the chamber and the first opening remains in communication with the chamber.

17. The selection manifold of claim 16 wherein the manifold block comprises at least two cells.

18. The selection manifold of claim 16 wherein the first inlet opening for each cell is supplied by a first manifold block inlet and the second inlet opening for each cell is supplied by a second manifold block inlet opening.

19. A beverage selection manifold comprising:
a) a manifold block containing an outlet opening positioned intermediate to first and second opposed inlet openings; and
b) a fluid seal having a first seating surface opposite a second seating surface,
wherein the fluid seal is moveable to a first position in which the first seating surface seals the first inlet opening and the second inlet opening remains open, and to a second position in which the second seating surface seals the second inlet opening and the first inlet opening remains open.

20. A beverage selection manifold comprising:
a) a cell within a manifold body, the cell including an outlet opening and first and second inlet openings; and
b) a removable cap including a channel therein positionable adjacent to the cell in a first cap position and a second cap position,
wherein the channel allows fluid communication between the outlet opening and the first inlet opening in the first position and between the outlet opening and the second inlet opening in the second position.

21. The beverage selection manifold of claim 20 further comprising an attachment device configured to hold the cap against the manifold body.

22. The beverage selection manifold of claim 20 wherein
a) in the first cap position, a fluid enters the manifold body from the first inlet opening and passes to the outlet opening through the channel of the removable cap and a fluid from the second inlet opening is prevented from entering the cell, and
b) in the second cap position, a fluid enters the cell from the second inlet opening and passes to the outlet opening through the channel of the removable cap and a fluid from the first inlet opening is prevented from entering the cell.

23. A method of switching a supply line to a dispensing valve comprising a user selecting the fluid supply to a beverage valve by activating a fluid seal between a first position in which a first side of the fluid seal closes a first fluid supply line, while allowing fluid to flow through a second fluid supply line, and a second position in which a second side of the fluid seal closes the second fluid supply line, while allowing fluid to flow through the first fluid supply line.

24. A method of switching a supply line to a dispensing valve comprising a user selecting the fluid supply to a beverage valve by positioning a cap in a first position in which a first side of the cap closes a first fluid supply line, while allowing fluid to flow through a second fluid supply line, and a second position in which a second side of the cap closes a second fluid supply line, while allowing fluid to flow through the first fluid supply line.

25. A selection manifold for use with a beverage dispenser comprising:
a) a valve body containing multiple cells, each cell having an outlet opening and first and second inlet openings;
b) a rotatable shuttle valve associated with each cell, the rotatable shuttle valve including first and second o-rings separated by a reduced diameter section, the shuttle valve being actionable between
i) a first position in which fluid entering the cell from the first inlet opening may pass to the outlet opening and fluid from the second inlet is prevented from entering the cell by the second o-rings, and
ii) a second position in which fluid entering the cell from the second inlet opening may pass to the outlet opening and fluid from the first inlet opening is prevented from entering the cell by the fist o-rings;
c) a retaining boss on the shuttle valve intermediate to first and second locking grooves,
d) a locking plate positioned on the valve body,
wherein the shuttle valve can be rotated, such that the retaining boss abuts the locking plate and the locking plate engages one of the first and second locking grooves to prevent unintentional change of the selector mechanism between the first and second positions.

26. A selection manifold for use with a beverage dispenser comprising:
a) a manifold block containing at least one cell, each cell having an outlet opening and at least first and second inlet openings; and
b) a selector mechanism associated with each cell, the selector mechanism being actionable between
i) a first position in which fluid entering the cell from the first inlet opening may pass to the outlet opening and fluid from the second inlet is prevented from entering the cell, and
ii) a second position in which fluid entering the cell from the second inlet opening may pass to the outlet opening and fluid from the first inlet opening is prevented from entering the cell,
wherein the selector mechanism includes a portion that extends past an outer edge of the manifold block enabling a viewer to determine the position of the selector mechanism associated with each cell.

27. The selection manifold of claim 26 wherein the portion that extends past and an outer edge of the manifold block comprises a handle that can be grasped by a user for positioning the selector mechanism to the first position or the second position.

28. A beverage selection manifold comprising:
a) a manifold body;
b) a plurality of sections within the manifold body, each section including first and second outlet orifices and first and second inlet orifices; and
c) a plurality of removable caps each including a channel therein positionable adjacent to one of the sections in a first cap position and a second cap position,
wherein the channel provides a fluid outlet for the first outlet orifice in the first position and a fluid outlet for the second outlet orifice in the second position.

29. The beverage selection manifold of claim 28 further comprising an attachment device configured to hold the cap against the manifold body.

30. The beverage selection manifold of claim 28 wherein the carbonated water flows through the removable cap in the first position and non-carbonated water flows through the removable cap in the second position.

31. The beverage selection manifold of claim 28 wherein the beverage selection manifold is integrated into the mounting block for a mixing and dispensing valve.

32. A beverage selection manifold for controlling fluid flow therein of carbonated and non-carbonated water for mixing with a syrup to form a beverage, the manifold comprising:
a) a rectangular manifold body including multiple cells, each cell having first and second inlet orifices and first and second outlet orifices, wherein the first and second inlet orifices are connected to respective first and second elongated channels positioned in the rectangular manifold body; and
b) at least one detachable body,
wherein the detachable body is configured to stop fluid flow from a first outlet orifice in a first position and from a second outlet orifice in a second position.

33. The beverage selection manifold of claim 32 wherein the detachable body further comprises a portion that extends past an outer edge of the manifold body, such that the portion can be grasped by a user for positioning the detachable body in the first position or the second position.

34. The beverage selection manifold of claim 32 wherein the first and second inlet orifices are configured for flow of carbonated and non-carbonated water, respectively, and wherein the detachable body enables a selection of either carbonated water or non-carbonated water for each of first and second outlet orifices.

35. The beverage selection manifold of claim 32 wherein the beverage selection manifold is integrated into a mounting block for a mixing and dispensing valve.

36. The beverage selection manifold of claim 32 wherein the at least one detachable body comprises a removable cap including a channel therein, the cap positionable adjacent one of the cells in a first cap position and a second cap position, wherein the channel allows fluid communication between one of the first or second outlet openings and the first inlet fluid path in the first position and between one of the first or second outlet openings and the second inlet fluid path in the second position.

37. A beverage selection manifold comprising:
a) a section within a manifold body, the section including first and second outlet openings and first and second inlet openings; and
b) a positionable body including a fluid path therein positionable adjacent to the section in a first body position and a second body position,
wherein the fluid path provides a fluid outlet for the first outlet opening in the first position and a fluid outlet for the second outlet opening in the second position.

38. A method of switching a supply line to a mixing and dispensing valve comprising:
a) providing a plurality of mixing and dispensing valves in fluid communication with a manifold block, the manifold block having a carbonated water channel and a noncarbonated water channel therethrough and a plurality of paired first and second outlet openings, each pair associated with one of the mixing and dispensing valves;
b) providing a removable selector for each of the plurality of mixing and dispensing valves;
c) connecting one of the removable selectors to one of a carbonated water supply or a non-carbonated water supply to a selected one of the plurality of mixing and dispensing valves by positioning a first removable selector in a first position in which the removable selector closes the first paired outlet opening, while allowing carbonated water or non-carbonated water to flow through the second paired outlet opening; and thereafter
d) switching the first removable selector body to select the other of a carbonated water supply or a non-carbonated water supply to the selected one of the plurality of mixing and dispensing valves by positioning the first removable selector body in a second position in which the first removable selector body closes the second paired outlet opening, while allowing carbonated water or noncarbonated water to flow through the first paired outlet opening.

39. The method of claim 38 wherein positioning the first removable selector body in a first position comprises:
a) grasping a portion of the first removable selector body that extends past an outer edge of the manifold block and removing the first removable selector body from the manifold block; and
b) returning the first removable selector body to the manifold block in the second position.

40. The method of claim 38 further comprising positioning a retaining device against the manifold block to hold the first removable selector body in place.

41. (New) A method of setting up a beverage dispenser comprising:
a) providing the beverage dispenser with a beverage selection manifold comprising:
i) a manifold block having first and second inlet channels therethrough and at least five paired first and second outlet openings therein; and
ii) a removable selector body associated with each paired first and second outlet opening;
b) positioning one of the removable selector bodies in a first position in which carbonated water entering the manifold block through the first inlet channel passes through the first paired outlet opening and noncarbonated water from the second inlet channel is prevented from passing through the second outlet opening; and
c) positioning another of the removable selector bodies in a second position in which noncarbonated water entering the manifold block through the second inlet channel passes through the second paired outlet opening and carbonated water from the first inlet channel is prevented from passing through the first paired outlet opening.

42. The method of claim 41 further comprising attaching a retaining device to the manifold block to prevent unintentional change of one or more of the removable selector bodies between the first position and the second position.

43. A beverage selection manifold for controlling fluid flow therein of carbonated and non-carbonated water for mixing with a syrup to form a beverage, the manifold comprising:
a) a manifold body including multiple cells, each cell having first and second inlet orifices and first and second outlet orifices,
wherein the first and second inlet orifices are connected to respective first and second elongated channels positioned in the manifold body; and
b) at least one detachable body,
wherein the at least one detachable body is configured to stop fluid flow from a first outlet orifice in a first position and from a second outlet orifice in a second position; and
(c) a retaining device to prevent unintentional change of the at least one detachable body between the first and second position.

44. The beverage selection manifold of claim 43 wherein the at least one detachable body further comprises a portion that extends past an outer edge of the manifold body, such that the portion can be grasped by a user for positioning the detachable body in the first position or the second position.

45. The beverage selection manifold of claim 56 wherein the first and second inlet orifices are configured for flow of carbonated and non-carbonated water, respectively, and wherein the detachable body enables a selection of either carbonated water or non-carbonated water for each of the first and second outlet orifices.

46. The beverage selection manifold of claim 43 wherein the first and second elongated channels comprise independent channels in the manifold body, each elongated channel having an opening at an end surface of the manifold body, and wherein the openings are adjacent to one another at the end surface.

47. The beverage selection manifold of claim 43 wherein the at least one detachable body comprises a body having a fluid channel therethrough.

48. The beverage selection manifold of claim 43 wherein the manifold body comprises a thermoplastic material.

49. The beverage selection manifold of claim 43 wherein the manifold body is integrated into a mounting block for a beverage dispenser.

50. The beverage selection manifold of claim 43 wherein the at least one detachable body comprises a removable cap including a channel therein, the cap positionable adjacent one of the cells in a first cap position and a second cap position, wherein the channel allows fluid communication between one of the first or second outlet orifices and the first inlet orifice in the first position and between one of the first or second outlet orifices and the second inlet orifice in the second position.

51. A beverage selection manifold for controlling fluid flow therein of carbonated and non-carbonated water for mixing with a syrup to form a beverage, the manifold comprising:
a) a rectangular manifold body including multiple cells, each cell having first and second inlet orifices and first and second outlet orifices,
wherein the first and second inlet orifices are connected to respective first and second elongated channels positioned in the rectangular manifold body; and
b) at least one detachable body,
wherein the detachable body is configured to stop fluid flow from a first outlet orifice in a first position and from a second outlet orifice in a second position, and
wherein the at least one detachable body further comprises a portion that extends past an outer edge of the rectangular manifold body, such that the portion can be grasped by a user for positioning the at least one detachable body in the first position or the second position.

52. The beverage selection manifold of claim 51 wherein the at least one detachable body comprises a removable cap including a channel therein, the cap positionable adjacent one of the cells in a first cap position and a second cap position, wherein the channel allows fluid communication between one of the first or second outlet orifices and the first inlet orifice in the first position and between one of the first or second outlet orifices and the second inlet orifice in the second position.
